(19) United States
(12) Patent Application Publication
(10) Pub. No.: US 2004/0216389 A1
(43) Pub. Date: Nov. 4, 2004

(54) Chemical mechanical polishing slurry

(75) Inventors: Yasuaki Tsuchiya, Kawasaki (JP); Toshiji Taiji, Kawasaki (JP); Tetsuyuki Itakura, Taito-ku (JP); Shin Sakurai, Taito-ku (JP); Kenichi Aoyagi, Taito-ku (JP); Tomoyuki Ito, Taito-ku (JP)

Correspondence Address: SUGHRUE MION, PLLC, 2100 PENNSYLVANIA AVENUE, N.W., SUITE 800, WASHINGTON, DC, 20037, US

(73) Assignees: NEC ELECTRONICS CORPORATION; TOKYO MAGNETIC PRINTING CO., LTD

(21) Appl. No.: 10/777,089

(22) Filed: Feb. 13, 2004

(30) Foreign Application Priority Data
Feb. 25, 2003 (JP) 2003-047552

(51) Int. Cl. C09K 3/14; B24D 3/02

(52) U.S. Cl. 51/307; 51/308; 51/309; 106/3

(57) ABSTRACT

This invention relates to a chemical mechanical polishing slurry comprising polishing grains, ammonium nitrate as an oxidizing agent, 1,2,4-triazole as a polishing promoter for a copper metal film and water and having a pH within a range of 3 to 4. The polishing slurry is suitable for forming a damascene copper-based metal interconnection comprising a tantalumr-based metal as a barrier metal film material.

### BACKGROUND OF THE INVENTION

1. Field of the Invention

This invention relates to a chemical mechanical polishing slurry for manufacturing a semiconductor device. In particular, it relates to a chemical mechanical polishing slurry suitable for forming a damascene copper-based metal interconnection comprising a tantalum-based metal as a barrier metal film material.

2. Description of the Related Art

With regard to forming a semiconductor integrated circuit such as ULSI which has been significantly refined and compacted, copper is a useful material for electric connection whereby a high-performance and highly reliable interconnection can be formed, because of its lower electrical resistance and good electromigration or stress-migration resistance.

Since copper is less processable by dry etching, a copper interconnection has been formed by a so-called damascene process. For example, an electric connection such as an interconnection may be formed as described below.

First, a concave such as a groove and a connection hole is formed on an insulating film formed on a silicon substrate. After forming a barrier metal film on the surface comprising the concave, a copper film is formed by plating such that the concave is buried. Then, the surface is polished to be flattened by chemical mechanical polishing (hereinafter, referred to as “CMP”) until the surface of the insulating film except the concave area is completely exposed. As a result, an electric connection such as a damascene interconnection, a via plug and a contact is formed, in which the concave is filled with copper via a barrier metal film.

Generally, for forming a damascene type electric connection, a barrier metal film is formed as described above in order to prevent dispersion of a copper metal into an insulating film or improve adhesiveness of the copper metal to a substrate (insulating film). Examples of a suitable barrier metal film to a copper-based metal film include a tantalum-based metal such as Ta and TaN.

Polishing such a copper-based metal film formed via a tantalum-based metal film, must be conducted, taking differences in polishing rates between the copper-based metal film and the tantalum metal and the insulating films into account.

Since the concave in the insulating film must be buried, the copper-based metal film is formed as a thick film. A polishing slurry capable of polishing the copper-based metal film at a high speed is usually used for effectively polishing and removing the thick copper-based metal film. A polishing rate is, however, generally reduced when the polishing slurry is used for a tantalum-based metal film. As a result, when attempting to adequately polish and remove the tantalum-based metal film, the copper-based metal film in the concave is excessively removed, leading to dishing.

Thus, for preventing such dishing, there has been proposed a two-step polishing process comprising a first polishing step for mainly polishing and removing the thick copper-based metal film for burying and a second polishing step for mainly polishing and removing the tantalum-based metal film.

In the first polishing step, it is required to effectively polish and remove the thick burying copper-based metal film and to prevent dishing at the end of the first polishing step. In the second polishing step, it is required to effectively polishing not only a small amount of the residual burying copper-based metal film after the first polishing step but also the tantalum-based metal film and to flatten the polished surface using the insulating film as a stopper.

In the second polishing step for mainly polishing and removing the tantalum-based metal film in such a two-step polishing process, a CMP slurry in which mechanical action contributes to polishing more than chemical action is generally used because the tantalum-based metal film is harder than the copper-based metal film. However, excessive mechanical polishing action for achieving an adequate polishing rate may cause excessive polishing of the insulating film and/or a rough polishing surface, so that a good electric connection cannot be formed. For preventing excessive polishing of the insulating film, it is effective to use a polishing slurry whose pH is adjusted to be acidic. However, it causes increase in chemical polishing action and thus increase in a polishing rate of the burying copper-based metal film. As a result, it may increase a difference in a polishing rate between the copper and the tantalum-based metal films, leading to dishing and/or erosion.

A commonly used CMP slurry comprises polishing grains, an oxidizing agent, a protective-film forming agent, an acid and water, and there have been various modifications for it in order to solve the above problems.

Patent reference 1 (Japanese Laid-open Patent Publication No. 83780/1996) has described that ionization of copper by an oxidizing agent such as hydrogen peroxide and dishing in a CMP process may be prevented by using a polishing slurry containing benzotriazole or its derivative as a protective-film forming agent and forming a protective film on a copper film surface. Patent reference 2 (Japanese Laid-open Patent Publication No. 238709/1999) has also described that a triazole-based compound such as benzotriazole and 1,2,4-triazole is effective for preventing dishing. However, when using the conventional polishing slurry comprising the protective-film forming agent, there have been limitations to a covering amount of the copper film by the protective-film forming agent and to an inhibiting effect to polishing the copper film. Particularly, it has been difficult to inhibit polishing of the copper film in a strongly acidic range where copper tends to be oxidized.

Patent reference 3 (Japanese Laid-open Patent Publication No. 85372/2001) has described a process wherein a polishing fluid comprising an oxidizing agent, a protective-layer forming agent, an acid and water with a pH of 3 or lower may be used and a concentration of the oxidizing agent may be varied to adjust a polishing-rate ratio between a copper or copper-alloy film and a barrier metal film. Generally, a polishing rate for a copper-based metal film increases as a concentration of an oxidizing agent is increased, but a concentration of the oxidizing agent added must be carefully adjusted in an acidic range in which the copper metal film tends to be oxidized. That is, when a concentration level of the oxidizing agent in the polishing slurry is higher than a predetermined level even to minimal degree, the copper metal film is excessively polished. A desired polishing rate cannot be, therefore, achieved unless a concentration of the oxidizing agent is accurately adjusted. Hydrogen peroxide, a common oxidizing agent for a polishing slurry, tends to be deteriorated over time. Thus, it is added to and mixed with the polishing slurry by appropriate means such as a chemical blender immediately before use. However, it has been difficult to accurately and reproducibly adjust an oxidizing-agent concentration in such a process, particularly when a predetermined oxidizing-agent concentration is relatively lower.

Patent reference 4 (Japanese Laid-open Patent Publication No. 89747/2001) has described a process wherein a polishing composition with a pH within a range of 3 to 6 and without an oxidizing agent may be used to reduce a polishing rate for a copper film. However, without an oxidizing agent at all, a polishing rate for a copper film is extremely low even in an acidic range in which copper tends to be oxidized, so that the copper film to be removed cannot be completely removed. The reference has also described a method for controlling or regulate a polishing rate for a copper film by varying an amount of hydrogen peroxide added. However, as described above, it is difficult to adjust a polishing rate for a copper film to a desired rate by varying an amount of hydrogen peroxide added in a strongly acidic range in which copper tends to be oxidized.

As described above, it has been difficult according to the prior art to adjust a polishing rate for a copper-based metal film within a desired range for preventing excessive polishing of the copper-based metal film in a strongly acidic range in which copper tends to be oxidized.

### SUMMARY OF THE INVENTION

An objective of this invention is to provide a chemical mechanical polishing slurry whereby a tantalum-based metal film for a barrier metal film can be polished and removed at an adequate rate, excessive polishing of a copper-based metal film for a damascene interconnection can be prevented and dishing can be minimized.

According to the invention, there is provided a chemical mechanical polishing slurry comprising polishing grains, ammonium nitrate as an oxidizing agent, 1, 2, 4-triazole as a polishing promoter for a copper metal film and water and having a pH within a range of 3 to 4.

A CMP slurry of this invention can be used to easily adjust a polishing rate for a copper-based metal film even in a strongly acidic range where the copper-based metal film tends to be oxidized. Therefore, in a process where a copper-based metal film and a tantalum-based metal film are simultaneously polished to form a damascene interconnection of the copper metal film, a suitable polishing rate ratio of the copper-based metal film to the tantalum-based metal film can be obtained and thus dishing or erosion can be minimized.

### DETAILED DESCRIPTION OF PREFERRED EMBODIMENTS

Preferred embodiments of this invention will be described.

Examples of polishing grains which can be used in this invention include one or more selected from the group consisting of metal oxide polishing grains including aluminas such as α-alumina, θ-alumina, γ-alumina and fumed alumina; silicas such as fumed silica and colloidal silica; titania; zirconia; germania; ceria; and a combination of two or more selected from these metal oxide polishing grains. Among these, silica polishing materials such as colloidal silica and fumed silica are preferable in the light of prevention of excessive polishing in a copper-based metal film and/or scratches in a polished surface and stable dispersion in the slurry, and particular preference is given to colloidal silica. An average particle size of a silica polishing material (an average particle size determined regarding a secondary particle as a single particle when secondary particles are contained) is preferably 10 nm or more, more preferably 20 nm or more while being preferably 100 nm or less, more preferably 80 nm or less, as determined by light scattering diffraction method in the light of, for example, a polishing rate, dispersion stability and surface roughness of a polished surface.

A content of the polishing grain in a CMP slurry of this invention may be appropriately selected from the range of 0.1 to 10 wt % in the light of some factors such as polishing efficiency and polishing accuracy. Particularly, it is preferably 0.5 to 5 wt % in the light of a polishing rate, dispersion stability and a roughness in the polished surface.

The CMP slurry of this invention comprises 1,2,4-triazole as a polishing promoter for a copper-based metal film. 1,2,4-Triazole may act as a complex forming agent and form a complex with copper ion within a pH range described below to promote ionization of copper. Furthermore, 1,2,4-triazole may be combined with ammonium nitrate described later to adjust a polishing rate of the copper-based metal film to a suitable level.

A content of 1,2,4-triazole in this invention is preferably 0.05 wt % or more, more preferably 0.1 wt % or more to an overall CMP slurry while being preferably 5 wt % or less, more preferably 3 wt % or less. If a content of 1,2,4-triazole is too low, a polishing rate for a copper-based metal film is too low to adequately remove the copper-based metal film to be removed. Furthermore, if a content of 1,2,4-triazole is too high, dispersion stability is deteriorated.

The CMP slurry of this invention comprises ammonium nitrate as an oxidizing agent. Ammonium nitrate properly oxidizes a copper-based metal film within a pH range where copper tends to be oxidized, to ionize copper. Furthermore, 1,2,4-triazole described above may be combined to form a complex consisting of copper ion, nitrate ion and 1,2,4-triazole, resulting in promotion in copper ionization. Concentrations of ammonium nitrate and 1,2,4-triazole may be selected to adjust a polishing rate for a copper-based metal film within a suitable range.

In the CMP slurry of this invention, a weight ratio of 1,2,4-triazole to ammonium nitrate (1,2,4-triazole concentration/ammonium nitrate concentration) is preferably 5 or less, more preferably 4 or less, further preferably 3 or less in the light of prevention of dishing and erosion due to excessive polishing of copper. The weight ratio is preferably 0.01 or more, more preferably 0.05 or more in the light of sufficient effects in combination of ammonium nitrate and 1,2,4-triazole.

Using ammonium nitrate as an oxidizing agent provides the following advantages. When using an oxidizing agent such as hydrogen peroxide whose activity tends to be deteriorated over time, the oxidizing agent is generally added to and mixed with the CMP slurry by appropriate means such as a chemical blender immediately before use. In such a process, as a predetermined concentration of the oxidizing agent contained in the CMP slurry is lower, it becomes more difficult to reproducibly and accurately adjust an oxidizing agent concentration. In contrast, ammonium nitrate used in this invention is stable in the CMP slurry for a long period. Thus, it is not necessary to adding an oxidizing agent immediately before use. In other words, the agent can be contained in the slurry in advance and a desired polishing rate for the copper-based metal film can be easily and reproducibly achieved.

A content of ammonium nitrate in this invention is preferably 0.1 wt % or more, more preferably 0.3 wt % or more while being preferably 5 wt % or less, more preferably 3 wt % or less. If a content of ammonium nitrate is too low, a polishing rate for a copper-based metal film is too low to adequately remove the copper metal film to be removed. Furthermore, if a content of ammonium nitrate is too high, dispersion stability is deteriorated.

The total concentration of ammonium nitrate and 1,2,4-triazole in the CMP slurry of this invention is preferably 5 wt % or less, more preferably 4 wt % or less, further preferably 3 wt % or less in the light of dispersion stability.

The CMP slurry of this invention preferably has a pH within a range of 3 to 4. In a CMP slurry according to the prior art, 1,2,4-triazole is known to be a protective-film forming agent because it can be chemically adsorbed to an oxidized film formed in the surface of a copper-based metal film. However, within the pH range, 1,2,4-triazole can be combined with ammonium nitrate to promote ionization of copper and thus to promote polishing of the copper-based metal film. In a CMP using such a slurry, it is believed that ammonium nitrate properly ionizes the copper-based metal film while 1,2,4-triazole together with copper and nitrate ions forms a complex to promote ionization of copper.

At a too high pH of the CMP slurry, a copper-based metal film tends to form an oxidized layer in its surface and 1,2,4-triazole forms a protective layer on the oxidized layer, to reduce a polishing rate for a copper-based metal film. On the other hand, at a too low pH of CMP slurry, an amount of an acid required for adjusting a pH is increased so that a concentration of the salt of 1,2,4-triazole with the acid used for adjusting a pH is increased. As a result, complex-forming ability of 1,2,4-triazole to copper is reduced, resulting in reduction in a polishing rate for the copper-based metal film. Furthermore, when using a silica polishing material as polishing grains, a pH substantially deviating from the range of 3 to 4 deteriorates dispersion stability in the silica polishing material.

A pH of the CMP slurry can be adjusted using an acid or alkali according to a well-known method. Examples of an acid used in pH adjustment include inorganic acids such as nitric acid and sulfuric acid; organic acids such as formic acid and oxalic acid; and their salts. Examples of an alkali used in pH adjustment include alkali-metal hydroxides such as sodium hydroxide and potassium hydroxide; alkali-metal carbonates such as sodium carbonate and potassium carbonate; ammonia; and amines.

The CMP slurry of this invention may comprise a variety of additives such as dispersants, buffers and viscosity modifiers commonly used in a polishing slurry as long as they do not deteriorate the properties of the slurry.

A polishing slurry of this invention may be prepared by a common process for preparing a free-grain aqueous polishing slurry. For example, to an aqueous solvent are added a proper amount of the polishing material and, if necessary, a proper amount of a dispersing agent for dispersion. In such a dispersion process, an appropriate apparatus may be, if necessary, used, including an ultrasonic disperser and a bead mill. The other components may be added and mixed before or after dispersion.

CMP using a polishing slurry of this invention may be conducted, using, for example a procedure described below. First, a substrate is prepared, on which an insulating film is formed, a concave with a given pattern is formed on the insulating film and a tantalum-metal and a copper-metal films are deposited on the concave. The substrate is placed on a wafer carrier such as a spindle. The metal film surface to be polished in the substrate is contacted with a polishing pad attached on a surface plate such as a rotary plate under predetermined pressure. While supplying a polishing slurry between the substrate and the polishing pad, polishing is initiated by relatively moving the wafer and the polishing pad (e.g., rotating both). The polishing slurry may be supplied on the polishing pad from a separate supply pipe or from the surface plate side. If necessary, a pad conditioner is contacted with the surface of the polishing pad to condition the surface of the polishing pad.

A polishing slurry of this invention described above may be effectively used when polishing by CMP is conducted to a copper-based metal film on a substrate comprising an insulating film having concaves such as grooves and connection holes in which the copper metal film is formed over the whole surface of the barrier metal film such the concaves are buried, to form an electric connection such as a damascene interconnect, a via plug and a contact. Examples of an insulating film include a silicon oxide film, a BPSG film (boron phosphorous silicate glass film), an SOG film (spin on glass film), an SiOF film (silicon oxide with fluorine film), an HSQ film (hydrogen silsesquioxane film), an SiOC film (silicon oxide with carbon film), an MSQ film (methyl silsesquioxane film), a polyimide film, a parilen film (trade name, polyparaxylene film), a Teflon film and an amorphous carbon film. Examples of a barrier metal film suitable for a copper-based metal film, i.e., a copper film or a copper-alloy film mainly comprising copper include those made of a tantalum-based metal such as tantalum, tantalum nitride and tantalum nitride silicon.

The CMP slurry of this invention can be effectively used in a step from initiation of polishing of the tantalum-based metal film to final polishing and removing the tantalum-based metal film except the concaves to form an electric connection. It can be suitably used in the second polishing in the above two-step polishing process.

A composition ratio of the CMP slurry of this invention may be preferably adjusted such that a polishing rate for the copper-based metal film is preferably 20 nm/min or more, more preferably 30 nm/min or more while being preferably 100 nm/min or less, more preferably 90 nm/min or less, particularly preferably 80 nm/min or less. If a polishing rate for the copper-based metal film is too low, a copper-based metal film to be removed tends to remain and a throughput may be reduced. On the contrary, if a polishing rate for the copper metal film is too high, dishing or erosion tends to occur due to excessive polishing. A composition ratio of the CMP slurry of this invention may be desirably adjusted such that a polishing rate for the tantalum-based metal film is preferably 40 nm/min or more, more preferably 60 nm/min or more while being preferably 200 nm/min or less, more preferably 150 nm/min or less. If a polishing rate for the tantalum-based metal film is too low, a tantalum-based metal film to be removed tends to remain and a throughput may be reduced. On the contrary, if a polishing rate for the tantalum-based metal film is too high, an insulating film may be excessively polished or a polished surface may be coarse.

A ratio of a polishing rate for the copper-based metal film to that for the tantalum metal film (Cu/Ta polishing rate ratio) is preferably 1/3 to 1/1 in the light of minimizing dishing and erosion and preventing excessive polishing of the copper-based metal film while adequately polishing and removing the film. For example, CMP may be conducted using a slurry which has been prepared such that a polishing rate for the copper film is 20 to 100 nm/min and a ratio of the polishing rate for the copper film to that for the tantalum film (Cu polishing rate/Ta polishing rate) is 1/3 to 1/1, to form an excellent damascene copper interconnection.

### EXAMPLES

This invention will be further specifically described with reference to Examples.

CMP Conditions

CMP was conducted using a polisher (Speedfam Co. Ltd., SH-24). The polisher comprised a surface plate on which a polishing pad with a diameter of 61 cm (Rodel-Nitta Company, IC 1400) was attached. Polishing conditions were as follows: a polishing-pad contact pressure: 27.6 kPa; a polishing-pad polishing area: 1820 cm², a rotating speed of the surface plate: 80 rpm; a carrier rotating speed: 80 rpm; and a polishing slurry feeding rate: 100 mL/min.

The substrate to be polished was an Si substrate on which a copper or a tantalum films had been deposited by sputtering.

Determination of a Polishing Rate

A polishing rate was estimated from surface resistivity values before and after polishing. Four needle electrodes were aligned on a wafer with a given interval. A given current was applied between the outer two probes to detect a potential difference between two inner probes for determining a resistance (R′) and further the value is multiplied by a correction factor RCF (Resistivity Correction Factor) to obtain a surface resistivity (ρs′). A surface resistivity (ρs) is determined for a wafer film whose thickness (T) (nm) is known. The surface resistivity is inversely proportional to the thickness. Thus, when a thickness for a surface resistivity of ρs' is d, an equation:

d(nm)=(ρs×T)/ρs′

holds true. Using the equation, the thickness d can be determined. Furthermore, a variation between before and after polishing was divided by a polishing time to estimate a polishing rate. A surface resistivity was determined using a surface resistance detector (Mitsubishi Chemical Corporation, Four Probe Resistance Detector, Loresta-GP).

Preparation of a CMP Slurry

As shown in Tables 1 to 4, slurries comprising 3 wt % of a colloidal silica (Tama Chemical Co. Ltd., TOSL series, a primary particle size: about 70 nm), 1,2,4-triazole (available from ACROS), ammonium nitrate (available from KANTO KAGAKU) was prepared as Examples and Comparative Examples. Furthermore, CMP slurries of comparative examples were prepared, which comprised benzotriazole (KANTO KAGAKU) or glycine (KANTO KAGAKU) instead of 1,2,4-triazole and hydrogen peroxide instead of ammonium nitrate, respectively. Hydrogen peroxide was introduced into the slurries by adding and mixing 30 wt % aqueous hydrogen peroxide (KANTO KAGAKU) to the slurries. The CMP slurries thus prepared were used for CMP under the above conditions.

### Examples 1 to 3 and Comparative Examples 1 to 8

As is obvious from the results in Examples 1 to 3 and Comparative Examples 1 and 2 shown in Table 1, the CMP slurries comprising 1,2,4-triazole and ammonium nitrate provided an increased copper polishing rate at a pH within a range of 3 to 4 while a practical polishing rate for copper was not obtained a pH deviating the range of 3 to 4.

As is obvious from Comparative Examples 3 to 8 shown in Table 1, the slurries comprising benzotriazole or glycine instead of 1,2,4-triazole provided a substantially constant polishing rate for copper at a pH of 2.5 to 5, which was not practically useful.

These results indicate that a suitable polishing rate for a copper film can be obtained using the CMP slurries in Examples 1 to 3 comprising 1,2,4-triazole and having a pH within a range of 3 to 4.

### Examples 1, 4 to 6 and Comparative Example 9

As is obvious from the results in Examples 1, 4 to 6 shown in Table 2, the higher a concentration of 1,2,4-triazole was, the higher a polishing rate for copper was. In contrast, when using the CMP slurry without 1,2,4-triazole in Comparative Example 9, a suitable polishing rate for a copper film could not be obtained.

These results indicate that without 1,2,4-triazole, a suitable polishing rate for copper cannot be obtained in the presence of ammonium nitrate and that a polishing rate for copper can be adjusted by varying a 1,2,4-triazole concentration.

### Examples 1, 7 to 9 and Comparative Example 10

As is obvious from the results in Examples 1, 7 to 9 shown in Table 3, the higher a concentration of ammonium nitrate was, the higher a polishing rate for copper was. In contrast, when using the CMP slurry without ammonium nitrate in Comparative Example 10, a suitable polishing rate for a copper film could not be obtained.

These results indicate that without ammonium nitrate, a suitable polishing rate for copper cannot be obtained in the presence of 1,2,4-triazole and that a polishing rate for copper can be adjusted by varying an ammonium nitrate concentration.

### Example 10 and Comparative Examples 11 and 12

As is obvious from the results of Example 10 shown in Table 4, a suitable polishing rate ratio was obtained at an oxidizing agent (ammonium nitrate) concentration of 1 wt %. In contrast, using hydrogen peroxide as an oxidizing agent (Comparative Examples 11 and 12), a suitable polishing rate ratio was not obtained even when reducing an oxidizing agent concentration to 0.05 wt %. These results indicate that this invention can provide a desired polishing rate ratio and a CMP slurry in which an oxidizing agent concentration can be easily adjusted to a desired level.

TABLE 1

| | Polishing | Oxidizing | Complex | | Cu polishing |
|---|---|---|---|---|---|
| | material | agent | forming agent | | rate |
| | (wt %) | (wt %) | (wt %) | pH | (nm/min) |
| Example 1 | Colloidal | Ammonium | 1,2,4-Triazole | 3.5 | 48 |
| | silica | nitrate | (0.5) | | |
| | (3) | (1.0) | | | |
| Example 2 | Colloidal | Ammonium | 1,2,4-Triazole | 3 | 42 |
| | silica | nitrate | (0.5) | | |
| | (3) | (1.0) | | | |
| Example 3 | Colloidal | Ammonium | 1,2,4-Triazole | 4 | 35 |
| | silica | nitrate | (0.5) | | |
| | (3) | (1.0) | | | |
| Comp. | Colloidal | Ammonium | 1,2,4-Triazole | 2.5 | 10 |
| Exam. 1 | silica | nitrate | (0.5) | | |
| | (3) | (1.0) | | | |
| Comp. | Colloidal | Ammonium | 1,2,4-Triazole | 5 | 14 |
| Exam. 2 | silica | nitrate | (0.5) | | |
| | (3) | (1.0) | | | |
| Comp. | Colloidal | Ammonium | Benzotriazole | 3.5 | 9 |
| Exam. 3 | silica | nitrate | (0.5) | | |
| | (3) | (1.0) | | | |
| Comp. | Colloidal | Ammonium | Benzotriazole | 2.5 | 10 |
| Exam. 4 | silica | nitrate | (0.5) | | |
| | (3) | (1.0) | | | |
| Comp. | Colloidal | Ammonium | Benzotriazole | 5 | 5 |
| Exam. 5 | silica | nitrate | (0.5) | | |
| | (3) | (1.0) | | | |
| Comp. | Colloidal | Ammonium | Glycine | 3.5 | 14 |
| Exam. 6 | silica | nitrate | (0.5) | | |
| | (3) | (1.0) | | | |
| Comp. | Colloidal | Ammonium | Glycine | 2.5 | 11 |
| Exam. 7 | silica | nitrate | (0.5) | | |
| | (3) | (1.0) | | | |
| Comp. | Colloidal | Ammonium | Glycine | 5 | 9 |
| Exam. 8 | silica | nitrate | (0.5) | | |
| | (3) | (1.0) | | | |

TABLE 2

| | Colloidal | Ammonium | | | Cu polishing |
|---|---|---|---|---|---|
| | silica | nitrate | 1,2,4-Triazole | | rate |
| | (wt %) | (wt %) | (wt %) | pH | (nm/min) |
| Example 4 | 3 | 1.0 | 0.1 | 3.5 | 24 |
| Example 1 | 3 | 1.0 | 0.5 | 3.5 | 48 |
| Example 5 | 3 | 1.0 | 1.0 | 3.5 | 59 |
| Example 6 | 3 | 1.0 | 2.0 | 3.5 | 89 |
| Comp. | 3 | 1.0 | None | 3.5 | 14 |
| Exam. 9 | | | | | |

TABLE 3

| | Colloidal | Ammonium | | | Cu polishing |
|---|---|---|---|---|---|
| | silica | nitrate | 1,2,4-Triazole | | rate |
| | (wt %) | (wt %) | (wt %) | pH | (nm/min) |
| Example 7 | 3 | 0.1 | 0.5 | 3.5 | 21 |
| Example 8 | 3 | 0.5 | 0.5 | 3.5 | 45 |
| Example 1 | 3 | 1.0 | 0.5 | 3.5 | 48 |
| Example 9 | 3 | 2.0 | 0.5 | 3.5 | 57 |
| Comp. | 3 | None | 0.5 | 3.5 | 9 |
| Exam. 10 | | | | | |

TABLE 4

| | | | | | Cu | Ta | |
|---|---|---|---|---|---|---|---|
| | Polishing | Oxidizing | Complex | | polishing | polishing | Cu/Ta |
| | material | agent | forming agent | | rate | rate | polishing |
| | (wt %) | (wt %) | (wt %) | pH | (nm/min) | (nm/min) | rate ratio |
| Exam. | Colloidal silica | Ammonium | 1,2,4-Triazole | 3.5 | 48 | 84 | 0.57 |
| 10 | (3) | nitrate | (0.5) | | | | |
| | | (1.0) | | | | | |
| Comp. | Colloidal silica | Hydrogen | 1,2,4-Triazole | 3.5 | 241 | 79 | 3.07 |
| Exam. | (3) | peroxide | (0.5) | | | | |
| 11 | | (0.2) | | | | | |
| Comp. | Colloidal silica | Hydrogen | 1,2,4-Triazole | 3.5 | 99 | 83 | 1.19 |
| Exam. | (3) | peroxide | (0.5) | | | | |
| 12 | | (0.05) | | | | | |

1. A chemical mechanical polishing slurry comprising polishing grains, ammonium nitrate as an oxidizing agent, 1,2,4-triazole as a polishing promoter for copper metal film and water in which pH is within a range of 3 to 4.

2. The chemical mechanical polishing slurry as claimed in claim 1 wherein a concentration of 1,2,4-triazole is within a range of 0.05 to 5 wt %.

3. The chemical mechanical polishing slurry as claimed in claim 1 wherein a concentration of ammonium nitrate is within a range of 0.1 to 5 wt %.

4. The chemical mechanical polishing slurry as claimed in claim 1 wherein a weight ratio of 1,2,4-triazole to ammonium nitrate (1,2,4-triazole concentration/ammonium nitrate concentration) is within a range of 0.01 to 5.

5. The chemical mechanical polishing slurry as claimed in claim 1 wherein the total of an ammonium nitrate and a 1,2,4-triazole concentrations is 5 wt % or less.

6. The chemical mechanical polishing slurry as claimed in claim 1 comprising a silica as polishing grains wherein a content of the silica is within a range of 0.1 to 10 wt %.

7. The chemical mechanical polishing slurry as claimed in claim 1 wherein a composition ratio of the slurry is adjusted such that a polishing rate ratio of a copper film to a tantalum film (Cu polishing rate/Ta polishing rate) is 1/3 to 1/1.
